(19) United States
(12) Patent Application Publication
(10) Pub. No.: US 2021/0283990 A1
(43) Pub. Date: Sep. 16, 2021

(54) VEHICLE AIR CONDITIONING SYSTEM AND DETERIORATION DEGREE ESTIMATING METHOD

(71) Applicant: ISUZU MOTORS LIMITED, Shinagawa-ku, Tokyo (JP)

(72) Inventor: Kenichi TAKAHASHI, Fujisawa-shi, Kanagawa (JP)

(21) Appl. No.: 17/259,437

(22) PCT Filed: Jul. 8, 2019
(86) PCT No.: PCT/JP2019/026962

§ 371 Date: Jan. 11, 2021

(30) Foreign Application Priority Data
Jul. 11, 2018 (JP) 2018-131475

(51) Int. Cl. B60H 1/32; B60H 1/00

(52) U.S. Cl. CPC B60H 1/3225; B60H 1/3227; B60H 2001/3266; B60H 2001/3255; B60H 1/00428

(57) ABSTRACT

A vehicle air conditioning system sets a deterioration determination index, which is an index for determining the degree of deterioration of an electric motor, to an integrated value of the time for which a condition continues in which the temperature of the engine cooling water for cooling an internal combustion engine is at or above a preset set temperature, or to the number of times that the temperature of the engine cooling water is at or above the set temperature, and estimates the degree of deterioration of the electric motor on the basis of a total engine speed, which is the cumulative value of the engine speed, and on the deterioration determination index.

### TECHNICAL FIELD

The present disclosure relates to a vehicle air conditioning system, and a method of estimating a degree of deterioration of an electric motor in the vehicle air conditioning system.

### BACKGROUND ART

In general, a vehicle air conditioning system (a vehicle air conditioner) includes a compressor, a condenser, an expansion valve, and an evaporator, and cools an inside of a vehicle by circulating a refrigerant in the compressor, the condenser, the expansion valve, the evaporator, and the compressor in order while cooling the refrigerant with air (a traveling wind) or the like. The refrigerant is cooled in a condenser due to heat exchange with the traveling wind that is blown toward the condenser by a fan (a blower) (see, for example, Patent Literature 1). The fan is driven by a motor (an electric motor).

### CITATION LIST

### Patent Document

Patent Literature 1: JP-A-2005-030363

### SUMMARY OF THE INVENTION

### Technical Problem

The motor for driving the fan gradually deteriorates as the motor is used. When the motor fails, the vehicle air conditioning system will not function as a result. Therefore, it is important to replace the motor with a new one before the motor fails. It is conceivable to perform a periodic replacement without knowing an actual state and a degree of deterioration of the motor. However, in this case, a motor having a degree of deterioration at which the motor does not actually need to be replaced may be replaced.

An object of the present disclosure is to provide a vehicle air conditioning system and a deterioration degree estimating method that enable to accurately estimate a degree of deterioration of an electric motor for driving a blower for cooling a condenser in the vehicle air conditioning system.

### Solution to Problem

A vehicle air conditioning system of the present disclosure includes:

a condenser that cools a refrigerant circulating in the vehicle air conditioning system, which controls air conditioning of a space in a vehicle, due to heat exchange with a traveling wind;

a blower that blows the traveling wind to the condenser;

an electric motor that drives the blower; and

a control device,

in which a deterioration determination index, which is an index for determining a degree of deterioration of the electric motor, is set to an integrated value of time for which a state continues in which a temperature of engine cooling water for cooling an internal combustion engine is equal to or higher than a preset setting temperature, or a number of times that the temperature of the engine cooling water is equal to or higher than the setting temperature, and

the control device is configured to estimate the degree of deterioration of the electric motor based on a total number of engine rotation, which is a cumulative value of a number of engine rotation of the internal combustion engine, and the deterioration determination index.

A method of estimating the degree of deterioration of the electric motor in the vehicle air conditioning system of the present disclosure is a deterioration degree estimating method of estimating the degree of deterioration of the electric motor of the vehicle air conditioning system including a condenser that cools a refrigerant circulating in the vehicle air conditioning system, which controls air conditioning of a space in a vehicle, due to heat exchange with a traveling wind, a blower that blows the traveling wind to the condenser, and an electric motor that drives the blower, the deterioration degree estimating method including the steps of:

setting a deterioration determination index, which is an index for determining the degree of deterioration of the electric motor, to an integrated value of time for which a state continues in which a temperature of engine cooling water for cooling an internal combustion engine is equal to or higher than a preset setting temperature, or a number of times that the temperature of the engine cooling water is equal to or higher than the setting temperature, which are measured after the electric motor is provided in the vehicle air conditioning system; and

estimating the degree of deterioration of the electric motor based on a total number of engine rotation, which is a cumulative value of a number of engine rotation of the internal combustion engine, and the deterioration determination index, the total number of engine rotation and the deterioration determination index being measured after the electric motor is provided in the vehicle air conditioning system.

### Advantageous Effects of Invention

According to the present disclosure, the degree of deterioration of the electric motor is estimated in accordance with a utilization status of the engine, the degree of deterioration of the electric motor can be accurately estimated. As a result, the electric motor can be replaced at an appropriate time in accordance with the degree of deterioration of the electric motor, and replacement work of the electric motor during vehicle inspection and occurrence of a cost associated with the replacement work can be prevented.

### BRIEF DESCRIPTION OF THE DRAWINGS

FIG. 1 is a diagram showing a configuration of a vehicle air conditioning system of the present disclosure.

FIG. 2 is a diagram showing a cooling water circuit of an engine.

FIG. 3 is a diagram showing positional relations among the engine, a condenser, a fan, and a motor.

FIG. 4 is a diagram showing a control flowchart for estimating a degree of deterioration of an electric motor of the vehicle air conditioning system according to the present disclosure.

### DESCRIPTION OF EMBODIMENTS

Hereinafter, a vehicle air conditioning system and a method of estimating a degree of deterioration of an electric motor in the vehicle air conditioning system at the present disclosure will be described based on an embodiment shown in the drawings.

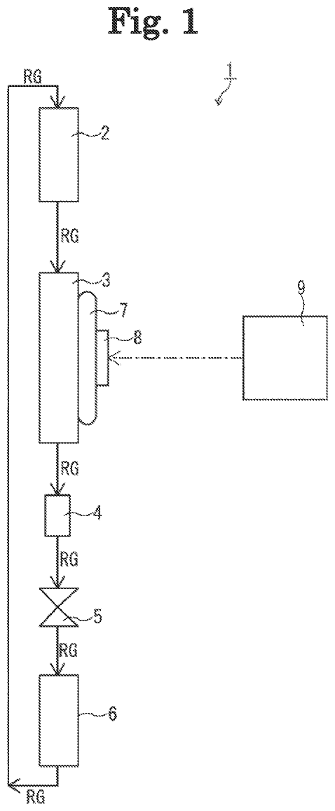

As shown in FIG. 1, a vehicle air conditioning system 1 of the present disclosure is a system for controlling air conditioning of a space in a vehicle, and includes a compressor 2, a condenser 3, an accumulator 4, an expansion valve 5, and an evaporator 6 in a circulation order of a refrigerant RG.

The compressor 2 is a device that compresses the refrigerant RG in a state of a gas with a low temperature and a low pressure to obtain the refrigerant RG in a state of a semi-liquid with a high temperature and a high pressure. The condenser 3 is a device that cools and condenses (liquefies) the refrigerant RG in the state of the semi-liquid with a high temperature and a high pressure after passing through the compressor 2 by causing the refrigerant RG in the state of the semi-liquid to exchange heat with a traveling wind, so as to obtain the refrigerant RG in a state of a liquid with a low temperature and a high pressure. The accumulator 4 is a gas-liquid separation device that separates the refrigerant RG remaining in a gas state from the refrigerant RG after passing through the condenser 3. The expansion valve 5 is a device that atomizes the refrigerant RG in the state of the liquid with a low temperature and a high pressure after passing through the condenser 3 and the accumulator 4. The evaporator 6 is a device that changes the atomized refrigerant RG with a low temperature and a high pressure after passing through the expansion valve 5 to the refrigerant RG in a state of a gas with a low temperature and a low pressure while heat of surroundings of the evaporator 6 is taken away.

The vehicle air conditioning system 1 includes a fan (a blower) 7 and a motor (an electric motor) 8. The fan 7 is a device that is disposed in a vicinity of the condenser 3 and blows the traveling wind to the condenser 3. The motor 8 is a brushed motor including a rotor serving as a rotation shaft and a brush supporting the rotor, and is connected to the fan 7. The vehicle air conditioning system 1 further includes a control device 9 that transmits a control signal for driving to the motor 8 in accordance with a temperature of the space in the vehicle.

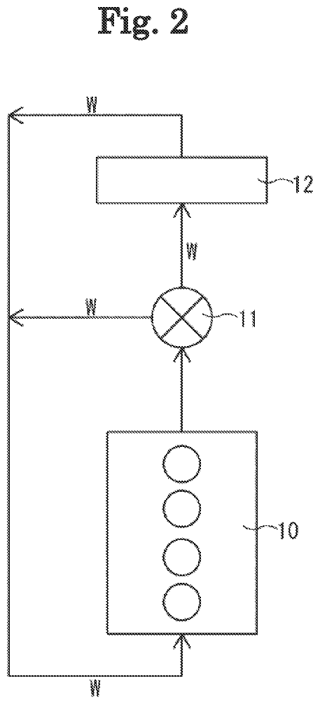

Here, a cooling circuit of an engine (an internal combustion engine) 10 serving as a power source of the vehicle will be described. As illustrated in FIG. 2, the cooling circuit of an engine 10 is a circuit through which engine cooling water W flows, and includes a thermostat 11 and a radiator 12 besides the engine 10.

The thermostat 11 is a device that sets, in accordance with a temperature Tw of the engine cooling water W, whether a flow path of the engine cooling water W is a flow path in which the engine cooling water W passes through the radiator 12. More specifically, when the temperature Tw of the engine cooling water W is equal to or higher than a preset setting temperature Tw1, it is determined that the engine 10 has a high load, and a capacity of cooling the engine is required to be increased. As a result, the engine cooling water W passes through the radiator 12 (a flowing order of the engine cooling water W being set as the engine 10, the thermostat 11, the radiator 12, and the engine 10).

On the other hand, when the temperature Tw of the engine cooling water W is lower than the setting temperature Tw1, it is determined that the engine 10 does not have a high load, and the capacity of cooling the engine is not required to be increased. As a result, the engine cooling water W does not pass through the radiator 12 (the flowing order of the engine cooling water W being set as the engine 10, the thermostat 11, and the engine 10).

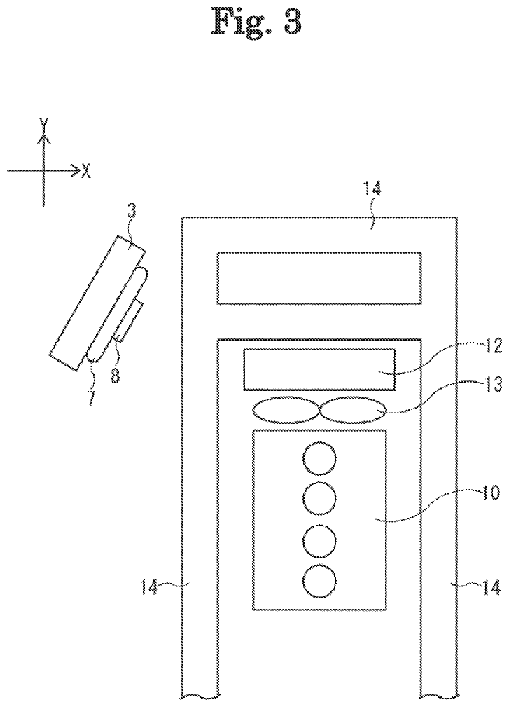

Regarding an arrangement of a cooling system of the engine 10, as shown in FIG. 3 as an example, the radiator 12, the engine fan 13, and the engine 10 are arranged at a substantial center of the vehicle in a width direction (X direction) in order from a front side of the vehicle in a travelling direction (Y direction), and are connected to a vehicle body frame 14 arranged around them. The engine fan 13 is a device that blows a traveling wind toward the engine 10, and is driven in accordance with the temperature Tw of the engine cooling water W. The condenser 3, the fan 7, and the motor 8 of the vehicle air conditioning system 1 are arranged via the vehicle body frame 14 on a left side in the X direction and a front side in the Y direction relative to the arrangement position of the engine 10.

In operation of the engine 10, when the temperature of the space in the vehicle where a driver is located is raised and the vehicle air conditioning system 1 is used, the fan 7 is driven by the motor 8 to perform heat exchange between the refrigerant RG and the traveling wind in the condenser 3. As a result, the degree of deterioration of the motor 8 (how much has the motor 8 deteriorated) increases. When the fan 7 is driven by the motor 8, the temperature Tw of the engine cooling water W also rises.

On the other hand, the degree of deterioration of the motor 8 is closely related to cumulative operation time and the number of times of driving starts or driving stops of the motor 8. The cumulative operation time and the number of times of driving starts or driving stops of the motor 8 is related to a total number of engine rotation of the engine 10, and the time for which the engine cooling water W has a high temperature, or each number of times that the temperature of the engine cooling water W rises and falls. Therefore, these parameters can be used to determine the degree of deterioration of the motor 8. Therefore, the present inventors have found that the degree of deterioration of the motor 8 can be estimated by using the total number of engine rotation of the engine 10 and a history of the temperature Tw of the engine cooling water W as an index for determining the degree of deterioration of the motor 8.

In the vehicle air conditioning system 1 of the present disclosure, the control device 9 estimates the degree of deterioration of the motor 8 based on the total number of engine rotation SNe and a deterioration determination index Iw of the motor 8 on the basis of the history of the temperature Tw of the engine cooling water W.

The total number of engine rotation SNe is a cumulative value of a number of engine rotation Ne measured after the motor 8 is provided in the vehicle air conditioning system 1. For example, when a unit of the number of engine rotation Ne is RPM (Rotation Per Minutes), a value obtained by multiplying the number of engine rotation Ne, which may vary each time, by operation time of the engine 10 represented by “minute” and cumulating the results of the multiplication, is the total number of engine rotation SNe. When the motor 8 is replaced with another equivalent product, the total number of engine rotation SNe is reset to 0.

The deterioration determination index Iw is an integrated value of the time for which a state continues in which the temperature Tw of the engine cooling water W is equal to or higher than the preset setting temperature Tw1, or the number of times that the temperature Tw of the engine cooling water W is equal to or higher than the setting temperature Tw1, which is measured after the motor 8 is provided in the vehicle air conditioning system 1. When the motor 8 is replaced with another equivalent product, the deterioration determination index Iw is reset to 0.

In this way, the degree of deterioration of the motor 8 is estimated in accordance with a utilization status of the engine 10, so that the degree of deterioration of the motor 8 can be accurately estimated by using data already detected and monitored, that is, the total number of engine rotation SNe and the history of the temperature Tw of the engine cooling water W. As a result, the motor 8 can be replaced at an appropriate time in accordance with the degree of deterioration of the motor 8, and unnecessary replacement work of the motor 8 during vehicle inspection and occurrence of an unnecessary cost associated with the replacement work can be prevented.

The control device 9 may calculate an abrasion amount WVb of the brush of the motor 8 based on the total number of engine rotation SNe and the deterioration determination index Iw, and may estimate the degree of deterioration of the motor 8 from the calculated abrasion amount WVb of the brush. In this case, the accuracy of estimating the degree of deterioration of the motor 8 can be improved by comparing the calculated abrasion amount WVb of the brush with the actual abrasion amount of the brush during the vehicle inspection or the like, and adding a correction amount, which is based on the comparison result, to the estimation control of the degree of deterioration of the motor 8.

The abrasion amount WVb of the brush may be calculated using map data based on the total number of engine rotation SNe and the deterioration determination index Iw. Alternatively, when the control device 9 calculates the abrasion amount WVb of the brush by linear calculation using a linear equation in which the total number of engine rotation SNe and the deterioration determination index Iw are weighted, it is preferred because the accuracy of calculating the abrasion amount WVb of the brush can be improved. The linear equation is, for example, the following equation (1).

WVb=α×SNe+β×Iw (1)

Here, WVb refers to the abrasion amount of the brush, SNe refers to the total number of engine rotation, Iw refers to the deterioration determination index, and α, β refer to weighting coefficients.

It is preferred because the control device 9 determines that the degree of deterioration of the motor 8 is an extent to which the replacement is required when the abrasion amount WVb of the brush is equal to or more than a preset setting threshold value WVb1, and further, if data such as a flag when the replacement is required is stored, whether the replacement of the motor 8 is required is more clarified only by seeing the flag (data) when data of a vehicle state at the time of vehicle inspection is displayed on a monitor. The progress of the degree of deterioration of the motor 8 is not so fast, so that the trouble of arranging the replacement by the driver is eliminated, traveling is continued in a state where the replacement of the motor 8 is determined to be necessary, and no major problem occurs even when the replacement of the motor 8 is performed during the vehicle inspection.

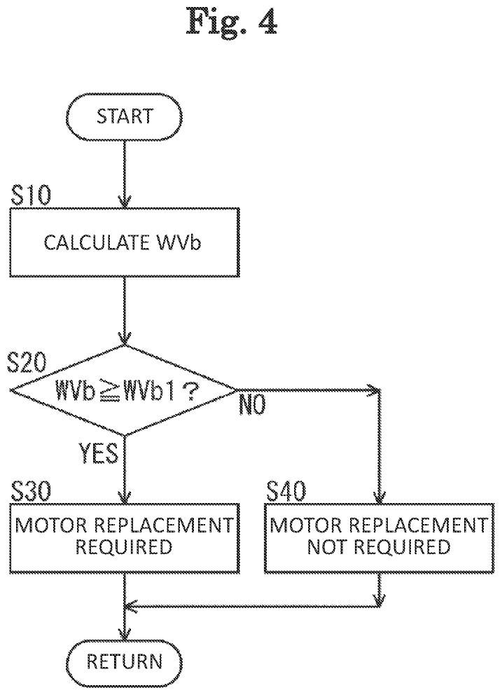

Next, a method of estimating the degree of deterioration of the electric motor in the vehicle air conditioning system at the present disclosure based on the vehicle air conditioning system 1 will be described with reference to a control flow in FIG. 4. The control flowchart in FIG. 4 is a control flowchart which is called from an advanced control flowchart when the vehicle is running.

When the control flow in FIG. 4 starts, the control device 9 calculates the abrasion amount WVb of the brush, which is an index of the degree of deterioration of the motor 8, based on the total number of engine rotation SNe and the deterioration determination index Iw in step S10. After the control in step S10 is performed, the process proceeds to step S20.

In step S20, the control device 9 determines whether the abrasion amount WVb of the brush is equal to or more than the setting threshold value WVb1. When the abrasion amount WVb of the brush is equal to or more than the setting threshold value WVb1 (YES), the process proceeds to step S30. In step S30, the control device 9 determines that the degree of deterioration of the motor 8 is the extent to which the replacement is required, and the determination result is stored in the control device 9. After the control in step S30 is performed, the process proceeds to “return”, and the control flow ends.

When the process proceeds from step S20 to step S30, the control flow ends and the process returns to the advanced control flow, and then, the control flow is not performed again unless the control device 9 receives a signal indicating that the replacement of the motor 8 is completed.

On the other hand, when the abrasion amount WVb of the brush is less than the setting threshold value WVb1 (NO) in step S20, the process proceeds to step S40, and the control device 9 determines that the degree of deterioration of the motor 8 is an extent to which the replacement is not required. After the control in step S40 is performed, the process returns to “return”, the control flow ends, and the control flow is performed again after a preset control interval has elapsed.

As described above, the method of estimating the degree of deterioration of the electric motor in the vehicle air conditioning system based on the vehicle air conditioning system 1 at the present disclosure is the method of estimating the degree of deterioration of the electric motor 8 in the vehicle air conditioning system 1 that includes the condenser 3 configured to cool the refrigerant RG circulating in the vehicle air conditioning system 1, which controls air conditioning of a space in a vehicle, due to heat exchange with a traveling wind, the blower 7 configured to blow the traveling wind to the condenser 3, and the electric motor 8 configured to drive the blower 7. The method includes: setting the deterioration determination index Iw, which is an index for determining the degree of deterioration of the electric motor 8, to an integrated value of time for which a state continues in which the temperature Tw of the engine cooling water W for cooling the internal combustion engine 10 is equal to or higher than the preset setting temperature Tw1 or the number of times that the temperature Tw of the engine cooling water W is equal to or higher than the setting temperature Tw1, which are measured after the electric motor 8 is provided in the vehicle air conditioning system 1; and estimating the degree of deterioration of the electric motor 8 based on the total number of engine rotation SNe, which is a cumulative value of the number of engine rotation Ne of the internal combustion engine 10, and the deterioration determination index Iw, which are measured after the electric motor 8 is provided in the vehicle air conditioning system 1.

According to the method, the same operation and effect as those of the vehicle air conditioning system 1 described above can be obtained.

The present application is based on Japanese Patent Application (No. 2018-131475) filed on Jul. 11, 2018, the contents of which are incorporated herein by reference.

### INDUSTRIAL APPLICABILITY

The vehicle air conditioning system and the method of estimating the degree of deterioration in the present disclosure are useful in that the degree of deterioration of the electric motor for driving the blower for cooling the condenser in the vehicle air conditioning system can be estimated accurately.

### LIST OF REFERENCE NUMERALS

1 Vehicle air conditioning system

2 Compressor (compressing unit)

3 Condenser (condensing unit)

4 Accumulator

5 Expansion valve

6 Evaporator (evaporating unit)

7 Fan (blower)

8 Motor (electric motor)

9 Control device

10 Engine (internal combustion engine)

11 Thermostat

12 Radiator

13 Engine fan

14 Vehicle body frame

RG Refrigerant

W Engine cooling water

Tw Temperature of engine cooling water

Tw1 Setting temperature

Ne Number of engine rotation

SNe Total number of engine rotation

Iw Deterioration determination index

WVb Abrasion amount of brush of motor

WVb1 Setting threshold value

1. A vehicle air conditioning system comprising:
a condenser that cools a refrigerant circulating in the vehicle air conditioning system, which controls air conditioning of a space in a vehicle, due to heat exchange with a traveling wind;
a blower that blows the traveling wind to the condenser;
an electric motor that drives the blower; and
a control device,
wherein a deterioration determination index, which is an index for determining a degree of deterioration of the electric motor, is set to an integrated value of time for which a state continues in which a temperature of engine cooling water for cooling an internal combustion engine is equal to or higher than a preset setting temperature, or a number of times that the temperature of the engine cooling water is equal to or higher than the setting temperature, and the control device is configured to estimate the degree of deterioration of the electric motor based on a total number of engine rotation, which is a cumulative value of a number of engine rotation of the internal combustion engine, and the deterioration determination index.

2. The vehicle air conditioning system according to claim 1,
wherein the electric motor is a brushed electric motor that includes a rotor serving as a rotation shaft, and a brush which supports the rotor, and
the control device is configured to:
calculate an abrasion amount of the brush based on the total number of engine rotation and the deterioration determination index; and
add a correction amount based on the calculated abrasion amount of the brush, to estimate the degree of deterioration of the electric motor.

3. The vehicle air conditioning system according to claim 2,
wherein the control device is configured to calculate the abrasion amount of the brush by a linear equation in which the total number of engine rotation and the deterioration determination index are weighted.

4. The vehicle air conditioning system according to claim 2,
wherein the control device is configured to determine that the degree of deterioration of the electric motor is an extent that replacement is required, if the abrasion amount of the brush is equal to or more than a preset setting threshold value.

5. The vehicle air conditioning system according to claim 1,
wherein the deterioration determination index and the total number of engine rotation are values measured after the electric motor is provided in the vehicle air conditioning system.

6. A deterioration degree estimating method of estimating a degree of deterioration of an electric motor in a vehicle air conditioning system including a condenser that cools a refrigerant circulating in the vehicle air conditioning system, which controls air conditioning of a space in a vehicle, due to heat exchange with a traveling wind, a blower that blows the traveling wind to the condenser, and the electric motor that drives the blower, the deterioration degree estimating method comprising the steps of:
setting a deterioration determination index, which is an index for determining the degree of deterioration of the electric motor, to an integrated value of time for which a state continues in which a temperature of engine cooling water for cooling an internal combustion engine is equal to or higher than a preset setting temperature, or a number of times that the temperature of the engine cooling water is equal to or higher than the setting temperature, which are measured after the electric motor is provided in the vehicle air conditioning system; and
estimating the degree of deterioration of the electric motor based on a total number of engine rotation, which is a cumulative value of a number of engine rotation of the internal combustion engine, and the deterioration determination index, the total number of engine rotation and the deterioration determination index being measured after the electric motor is provided in the vehicle air conditioning system.
